(19) United States
(12) Patent Application Publication
(10) Pub. No.: US 2016/0364572 A1
(43) Pub. Date: Dec. 15, 2016

(54) INPUT DEVICE FOR PREVENTING PASSWORD THEFT BY THERMAL IMAGING

(71) Applicant: INTERNATIONAL BUSINESS MACHINES CORPORATION, ARMONK, NY (US)

(72) Inventors: Guy M. Cohen, Ossining, NY (US); Lior Horesh, North Salem, NY (US); Mayank Sharma, White Plains, NY (US)

(21) Appl. No.: 14/739,725

(22) Filed: Jun. 15, 2015

(51) Int. Cl. G06F 21/60; G06F 3/02

(52) U.S. Cl. CPC G06F 21/60; G06F 3/0202

(57) ABSTRACT

Exemplary embodiments of the present invention provide an input device including a keyboard having at least two keys. A heating or cooling element is connected to each key. A sensor is configured to detect key temperature. A controller is connected to the sensor for controlling the key temperature.

### FIELD OF THE INVENTION

Exemplary embodiments of the present invention relate to an input device. More particularly, exemplary embodiments of the present invention relate to an input device for preventing password theft by thermal imaging.

### DISCUSSION OF RELATED ART

Generally, when an input device user enters a password on a keypad, the user transfers body heat to the input device. For example, the user may enter the password on the keypad by pressing a number of keys in a unique sequence. When the user presses each key, the user may transfer body heat from the user's finger or hand to the keys of the keypad that are pressed. Keys that have been pressed may be warmer than keys that have not been pressed on the keypad. Additionally, keys that have been pressed more recently may be relatively warmer than keys that have been pressed less recently. Thus, it may be possible to exploit a temperature of the keypad keys to reconstruct the sequence by which the keys were pressed and a password may be obtained.

The temperature of the individual keypad keys may be obtained by thermal imaging. For example, a bank ATM may be monitored by a thermal imaging device to identify a user's password based on thermal imaging on the keypad of the ATM.

### SUMMARY

Exemplary embodiments of the present invention provide an input device including a keyboard having at least two keys. A heating or cooling element is connected to each key. A sensor is configured to detect temperature of each key. A controller is connected to the sensor for controlling key temperature.

According to an exemplary embodiment of the present invention the key temperature may be maintained at a constant temperature.

According to an exemplary embodiment of the present invention the temperature may be maintained at or about human body temperature.

According to an exemplary embodiment of the present invention the key temperature may be maintained at different constant temperatures at different times.

According to an exemplary embodiment of the present invention the key temperature may be randomly varied over time.

According to an exemplary embodiment of the present invention the heating or cooling element may be embedded at each key.

According to an exemplary embodiment of the present invention the sensor may be embedded at each key.

According to an exemplary embodiment of the present invention the input device may include an infrared (IR) source configured to illuminate the keys with infrared light.

According to an exemplary embodiment of the present invention an infrared source may be embedded at each key.

According to an exemplary embodiment of the present invention the controller may implement a PID loop.

According to an exemplary embodiment of the present invention the heating or cooling element may include semiconductor material.

Exemplary embodiments of the present invention provide an input device including a keyboard having at least two keys and an infrared (IR) source configured to illuminate the keys with infrared light.

According to an exemplary embodiment of the present invention the IR source may be embedded at each key.

According to an exemplary embodiment of the present invention the at least two keys and the IR source may be connected to a common power source node within the input device.

Exemplary embodiments of the present invention provide an input device including a keyboard having at least two keys and a motorized cover that covers the at least two keys after each user session.

According to an exemplary embodiment of the present invention, a processor may execute stored codes to monitor the start and end of each user session.

Exemplary embodiments of the present invention provide an input device including a keyboard having at least two keys and a cover that covers the at least two keys. The cover is configured to block infrared light and to pass humanly visible light.

Exemplary embodiments of the present invention provide a touch screen input device including a processor that executes stored codes to present a keyboard having digits at different locations on the touch screen after each user session.

### BRIEF DESCRIPTION OF THE FIGURES

The above and other features of the present invention will become more apparent by describing in detail exemplary embodiments thereof, with reference to the accompanying drawings, in which:

FIG. 1 is a schematic diagram illustrating a keypad according to an exemplary embodiment of the present invention.

FIG. 2 is a schematic diagram illustrating a keypad according to an exemplary embodiment of the present invention.

FIG. 3 is a schematic diagram illustrating a keypad according to an exemplary embodiment of the present invention.

FIG. 4 is a diagram illustrating a keypad and an infrared (IR) light source according to an exemplary embodiment of the present invention.

FIG. 5 illustrates a device having a saturated thermal image according to an exemplary embodiment of the present invention.

FIG. 6 illustrates a keyboard including a blind cover according to an exemplary embodiment of the present invention.

FIG. 7 illustrates exemplary arrangements of a variable arrangement keypad displayed on a touch screen according to an exemplary embodiment of the present invention.

FIG. 8 illustrates an example of a computer system capable of implementing the method and apparatus according to embodiments of the present disclosure.

### DETAILED DESCRIPTION

Users of an input device, such as a keyboard or keypad may transfer body heat to the input device when the users hand or fingers contacts the input device. For example, users of a bank ATM may enter a password on a keypad in order to gain access to the user's account. The user may transfer body heat from the user's finger or hand to the keys of the keypad that are pressed. Keys that have been pressed may be warmer than keys that have not been pressed on the keypad. Thus, keys that have been pressed more recently may be relatively warmer than keys that have been pressed less recently.

It may be possible to exploit a temperature change of the keypad keys to reconstruct the sequence by which the keys were pressed and a password may be obtained. Thermal imaging, for example, may be used to obtain the temperature of individual keys of the keypad and to reconstruct the user's password.

Exemplary embodiments of the present invention provide an input device and methods for preventing password theft by thermal imaging. The temperature of keypad keys may be regulated. According to exemplary embodiments of the present invention, keypad keys may be kept at a constant temperature or a variable temperature. The variable temperature of the keypad keys may be randomly varied over time.

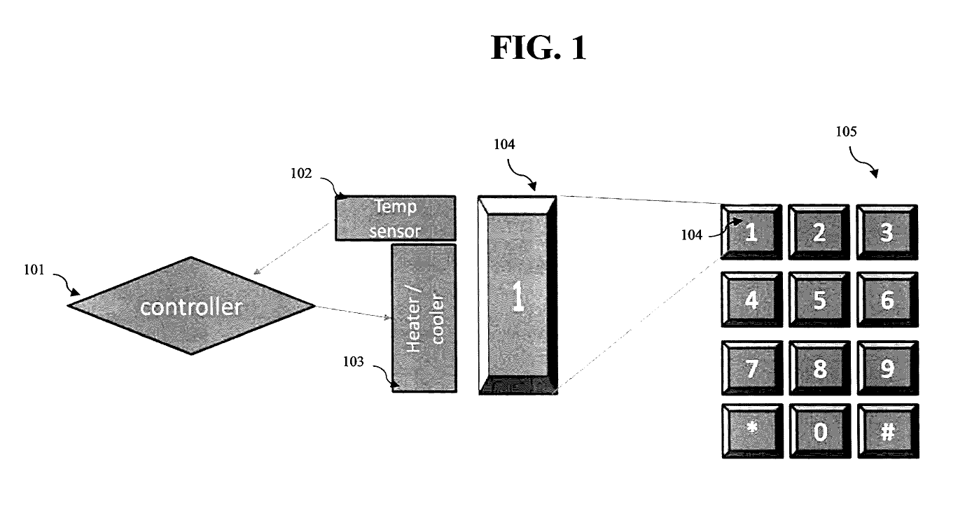

FIG. 1 is a schematic diagram illustrating a keypad according to an exemplary embodiment of the present invention.

Referring to FIG. 1, an input device may include a keyboard 105 having at least two keys 104. A heating or cooling element 103 may be connected to each key 104. A sensor 102 may be configured to detect temperature of each key 104. A controller 101 may receive input form the sensor 102 and may be connected to a heating or cooling element 103 for controlling key temperature. The heating or cooling element 103 may be embedded at each key 104. The heating or cooling element 103 may be a thermoelectric heater/cooler (e.g., based on the Peltier effect), a hot or cold air flow unit, which my pass hot or cold air over or through each of the at least two keys 104. For example, the hot or cold air flow unit may be embedded in each key, or may be an external hot or cold air flow unit. The heating or cooling element 103 may include a heating coil or resistor disposed at each of the at least two keys 104 to provide heat. The heating or cooling element 103 may include a thermoelectric cooler, for example, made from semiconductor materials to remove heat from the at least two keys 104. Similarly, the sensor 102, which may be a temperature sensor, may be embedded at each key 104.

According to exemplary embodiments of the present invention the keyboard 105 may have any number the at least two keys 104. A keyboard 105 including nine keys 104 is illustrated, for example, in FIG. 1 as an illustrative example, and exemplary embodiments of the present invention are not limited to this particular illustrative example. The at least two keys 104 may be arranged in any desired configuration, such as rows and or columns of any desired size or arrangement. Each of the at least two keys 104 may display any desired character, such as any desired alphanumerical character or any desired symbol. For example, each of the at least two keys 104 may display one or more characters from a QWERTY keyboard or keypad. The terms “keyboard” and “keypad” may be used interchangeably throughout the specification. The keyboard 105 may be a physical keyboard, or may be a digitally displayed keyboard. For example, the keyboard 105 having any desired arrangement of the at least two keys 104, each displaying any desired alphanumerical character. Alternatively, the keyboard may be digitally displayed on a device such as a Tablet computer, or a Smartphone.

According to an exemplary embodiment of the present invention, the two or more keys 104 may each be maintained at a constant temperature by the controller 101 and the heating or cooling element 103. The constant temperature may be substantially the same as a human body temperature. Human body temperature may be approximately 37° C. or 98.6° F. According to an exemplary embodiment of the present invention the keys 104 may be maintained at a temperature which is slightly above human body temperature. Thus, changes in the temperature of the keys 104 may be minimal when the keys are contacted by a users' hand or fingers.

According to an exemplary embodiment of the present invention, when the user has a relatively high body temperature (e.g., due to having a fever or a medical issue), the input device may detect the elevated body temperature and report such a detection to supervising personnel, such as a bank employee. If a high body temperature is detected, the supervising personnel may determine that the user may be ill, and that sterilizing or cleaning of the keyboard 105 is desired (e.g., to avoid transmitting bacteria or viruses between users).

According to exemplary embodiments of the present invention the sensor 102 may be the temperature sensor. The temperature sensor 102 may be a mechanical temperature sensor. The mechanical temperature sensor may include a thermometer or a bimetal temperature sensor. The temperature sensor 102 may be an electrical temperature sensor. The electrical temperature sensor may include a thermistor, a thermocouple, a resistance thermometer or a silicon bandgap temperature sensor. The temperature sensor 102 may include a diode. For example, the diode may be a semiconductor diode.

The keys 104 temperature may also be monitored using an IR camera that constantly images the keyboard 105. The “color” of each key 104 may be directly correlated to the key 104 temperature. The controller 101 may adjust the temperature of each key 104 to equalize the keys 104 “colors”, i.e. to have the same temperature.

According to an exemplary embodiment of the present invention, as shown for example in FIG. 1, a proportional-integral-derivative (PID) loop may be implemented. For example, the PID loop may be a fast PID loop. The PID loop may control the heating or cooling element 103 in each of the keys 104, and maintain the temperature of the keys 104 at a desired temperature.

According to exemplary embodiments of the present invention, the keys 104 may include a thermally conductive top surface. The top surface of the keys 104 may include a metal. The keys 104 may include a relatively thin plastic shell or frame with a thermally conductive metallic top surface. The thermally conductive top surface of the keys 104 may enable substantially uniform heating or cooling of the keys 104.

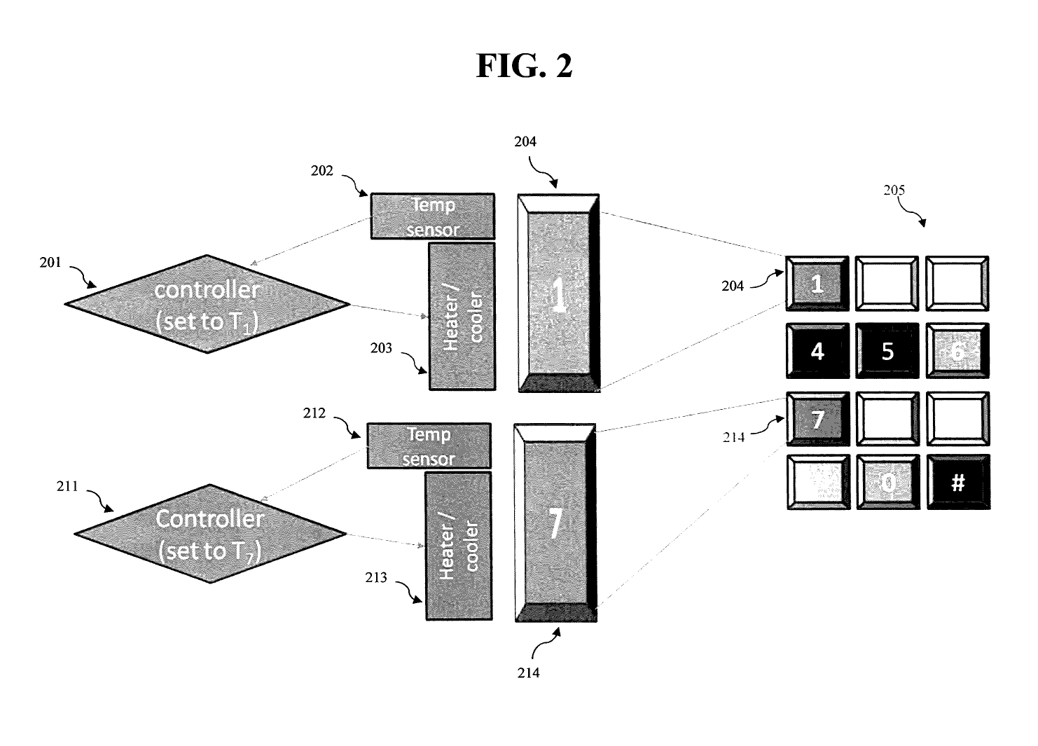

FIG. 2 is a schematic diagram illustrating a keypad according to an exemplary embodiment of the present invention. The elements described with reference to FIG. 2 may be substantially the same as the elements described with reference to FIG. 1, except that the keys illustrated in FIG. 2 may be maintained at different temperatures from each other.

Referring to FIG. 2 the input device may include a keyboard 205 having at least two keys (e.g., a first key 204 and a second key 214). A first heating or cooling element 203 may be connected to the first key 204 and a second heating or cooling element 213 may be connected to the second key 214. A first sensor 202 may be configured to detect temperatures of the first key 204 and a second sensor 212 may be configured to detect temperatures of the second key 214. Each of the first and second sensors 202 and 212 may be temperature sensors. A first controller 201 may be connected to the first sensor 202 and a second controller 211 may be connected to the second sensor 212. The first controller 201 may control the temperature of the first key 204 and the second controller 211 may control the temperature of the second key 214. Heating and/or cooling elements may be embedded in each key. For example, a first heating or cooling element 203 may be embedded at the first key 204 and a second heating or cooling element 213 may be embedded at the second key 214. Similarly, the sensors which may be temperature sensors may be embedded at each key. For example, the first sensor 202 may be embedded at the first key 204 and a second sensor 212 may be embedded at the second key 214.

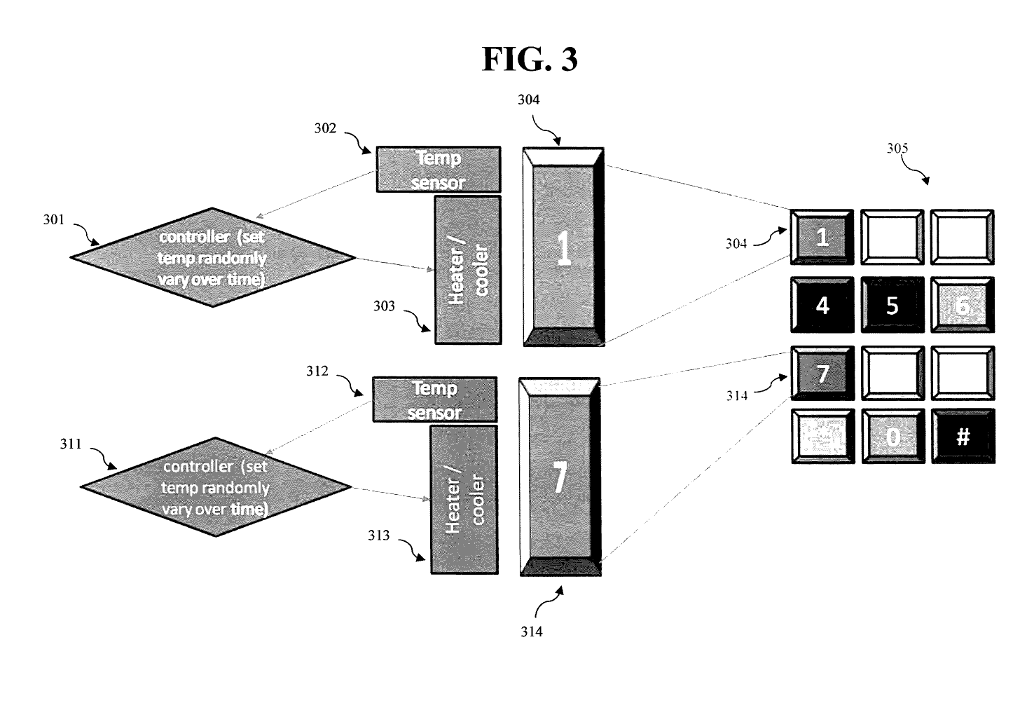

According to an exemplary embodiment of the present invention the keys (e.g., keys 204 and 214) may each be maintained at different constant temperatures at different times. As an illustrative example, FIG. 2 illustrates the keys (e.g., keys 204 and 214) in gray scale. Each key illustrated in FIG. 2 has a different level or darkness of gray, which indicates that each key may be maintained at a different temperature. In other words, different levels of darkness illustrated in FIG. 2 illustrates a different temperature of the keys. For example, at a particular point in time key 204 may be maintained at a first temperature T1 and key 214 may be maintained at a second temperature T2 that is different from the first temperature. The temperatures of each of the keys (e.g., keys 204 and 214) may be constantly changed. For example, as described below in more detail with reference to FIG. 3, the temperature of each of the keys (e.g., keys 204 and 214) may be randomly varied, and thus an occurrence of thermal detection of the user's password may be reduced or prevented.

FIG. 3 is a schematic diagram illustrating a keypad according to an exemplary embodiment of the present invention. The elements described with reference to FIG. 3 may be substantially the same as the elements described with reference to FIG. 2, except that the temperatures of the keys illustrated in FIG. 3 may be randomly varied.

Referring to FIG. 3 the input device may include a keyboard 305 having at least two keys (e.g., the first key 304 and a second key 314). A first heating or cooling element 303 may be connected to the first key 304 and a second heating or cooling element 313 may be connected to the second key 314. A first sensor 302 may be configured to detect temperatures of the first key 304 and a second sensor 312 may be configured to detect temperatures of the second key 314. Each of the first and second sensors 302 and 312 may be temperature sensors. A first controller 301 may be connected to the first sensor 302 and a second controller 311 may be connected to the second sensor 312. The first controller 301 may control the temperature of the first key 304 and the second controller 311 may control the temperature of the second key 314. Heating and/or cooling elements may be embedded in each key. For example, a first heating or cooling element 303 may be embedded at the first key 304 and a second heating or cooling element 313 may be embedded at the second key 314. Similarly, the sensors which may be temperature sensors may be embedded at each key. For example, the first sensor 302 may be embedded at the first key 304 and a second sensor 312 may be embedded at the second key 314.

According to an exemplary embodiment of the present invention the keys (e.g., keys 304 and 314) may each have different and variable temperatures at different times. For example, at a particular point in time key 304 may be maintained at a first temperature and key 314 may be maintained at a second temperature that is different from the first temperature. The temperatures of each of the keys (e.g., keys 304 and 314) may be constantly changed. That is, a same key (e.g., a first key 304) may have a first temperature at a first time point and may have another different temperature at another time point. The controllers 301 and 311 may set the temperature of each key randomly and may vary the temperatures over time, and thus an occurrence of thermal detection of the user's password may be reduced or prevented.

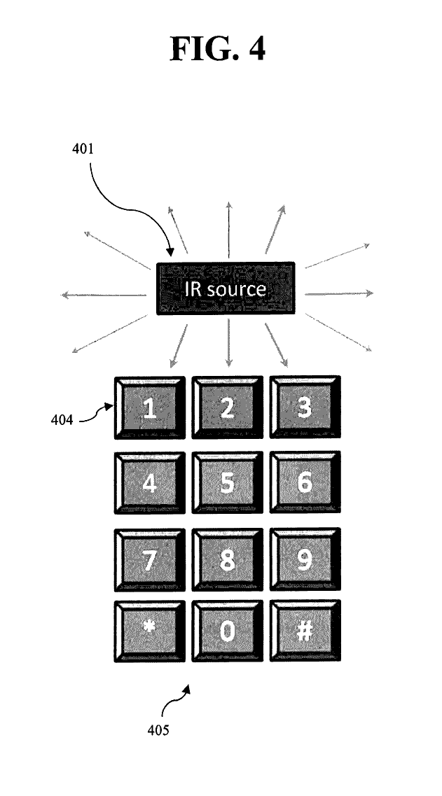

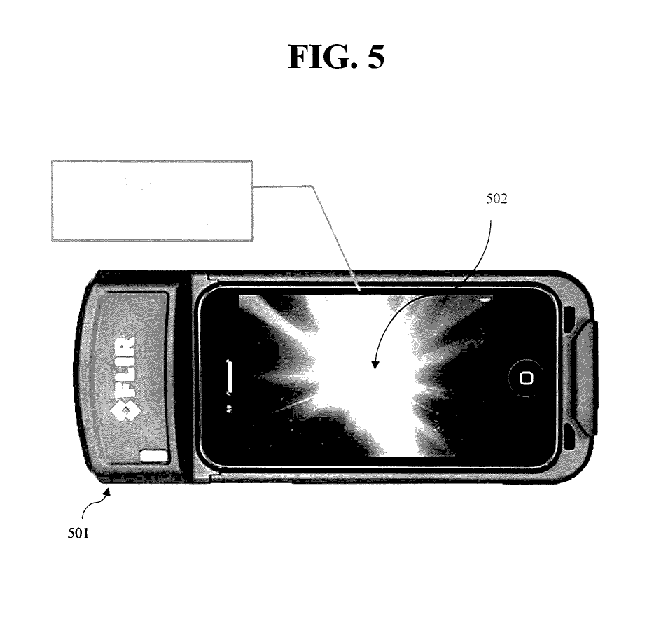

FIG. 4 is a diagram illustrating a keypad and an infrared (IR) light source according to an exemplary embodiment of the present invention. FIG. 5 illustrates a device, such as an imaging device, having a saturated thermal image according to an exemplary embodiment of the present invention.

Referring to FIGS. 4 and 5, the input device may include an infrared (LR) source 401 configured to illuminate keys 404 of a keyboard 405 with infrared light. The IR source 401 may be embedded at each key 404. When the IR source 401 illuminates the keyboard 405, the keyboard 405 may reflect the IR radiation. When the IR sources 401 are embedded in each key, IR radiation may be emitted from each key 404.

Exemplary embodiments of the present invention provide an input device including the keyboard 405 having at least two keys 404 and the IR source 401 configured to illuminate the keys 404 with infrared light. The at least two keys 404 and the IR source 401 may be connected to a common power source node within the input device. According to exemplary embodiments of the present invention, the IR source 401 may provide background radiation to the keyboard, which may blind a thermal imager attempting to determine a temperature of the keys 404. The keyboard 405 temperature may be masked by the background IR radiation. The IR Source 401 may be an external IR source, or may be integrally disposed at each key 404.

According to an exemplary embodiment of the present invention, a handheld device 501 may have a saturated thermal image 502. For example, the handheld device 501 may include an integrated IR source configured to flood a viewing area of the handheld device 501 with background radiation. For example, the IR source 401 may provide an IR photon flux which is at least 100 times larger than that provided by a passive key temperature. Thus, the input device according to exemplary embodiments of the present invention may reduce or prevent an occurrence of a password being detected or stolen by a thermal imager.

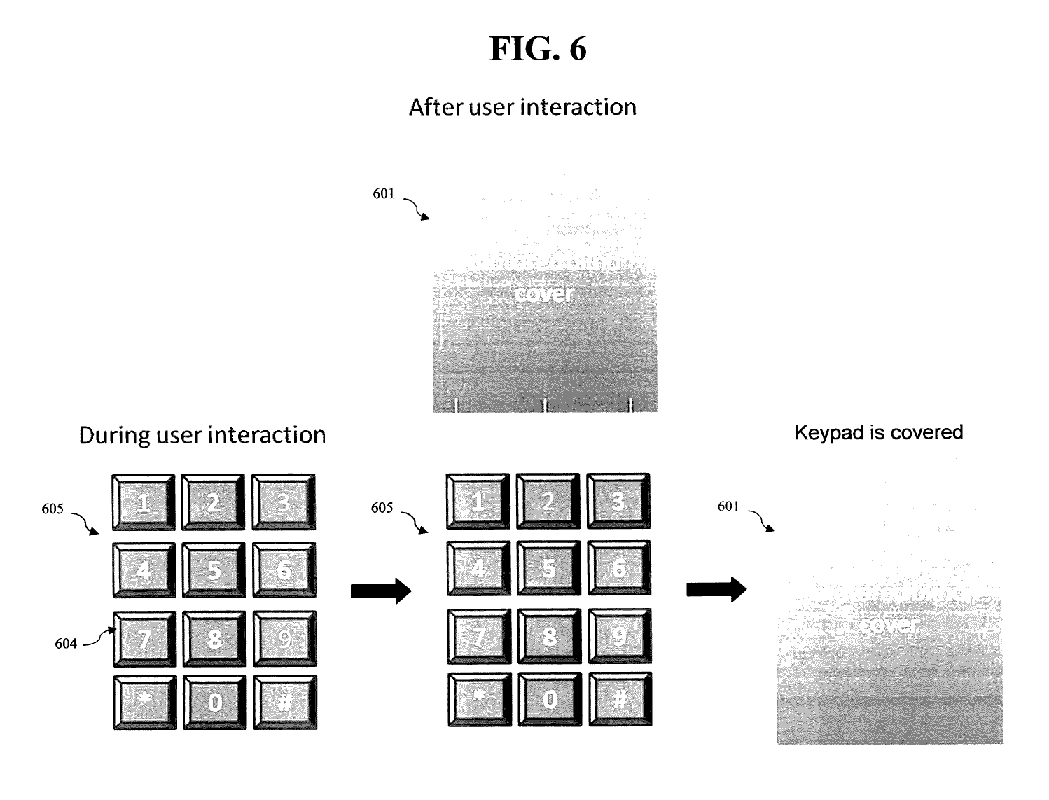

FIG. 6 illustrates a keyboard including a blind cover according to an exemplary embodiment of the present invention.

Referring to FIG. 6, the input device may include a keyboard 605 and a blind cover 601. The blind cover 601 may be configured to cover the keyboard 605, as desired. For example, the blind cover 601 may be configured to cover the keyboard 605 when the keyboard 605 is not in use. The blind cover 601 may be configured to block detection of temperatures of keys 604 of the keyboard 605 by a thermal imager. For example, the blind cover 601 may block IR wavelength thermal imaging of the keys 604 of the keyboard 605, but at the same time be transparent to visible light. This may further allow the use of a fixed cover over the keyboard 605.

Exemplary embodiments of the present invention provide the input device including the keyboard 605 having at least two keys 604 and a motorized cover (e.g., the blind cover 601) that covers the at least two keys 604 after each user session. According to an exemplary embodiment of the present invention, the user session may be started when the user approaches the input device. When the user session is started, the blind cover 601 may be retracted to expose the keyboard 605. The user session may be ended after the user has moved away from the keyboard 605. The user session may end when the user has not touched the keypad for a predetermined period of time (e.g., 20 seconds). The blind cover 601 may be retracted when the end of a user session is determined.

According to an exemplary embodiment of the present invention, a processor may execute stored codes to monitor the start and end of each user session. The blind cover 601 may be configured to expose the keyboard 605 during a user session and then cover the keyboard 605 when a user session is completed. Thus, the input device including the blind cover 601 according to exemplary embodiments of the present invention may block thermal imaging of the keyboard 605 and may reduce or prevent an occurrence of a password being detected or stolen by a thermal imager.

According to an exemplary embodiment of the present invention the blind cover 601 blocks infrared light but is transparent to visible light. When the blind cover 601 is transparent to visible light it may be provide without a motor and may be a fixed cover, and thus the keyboard 605 can be used by the user without retracting or removing the blind cover 601. Thus, the blind cover 601 may remain over the keys 604 before, during and after a user session, while blocking IR light.

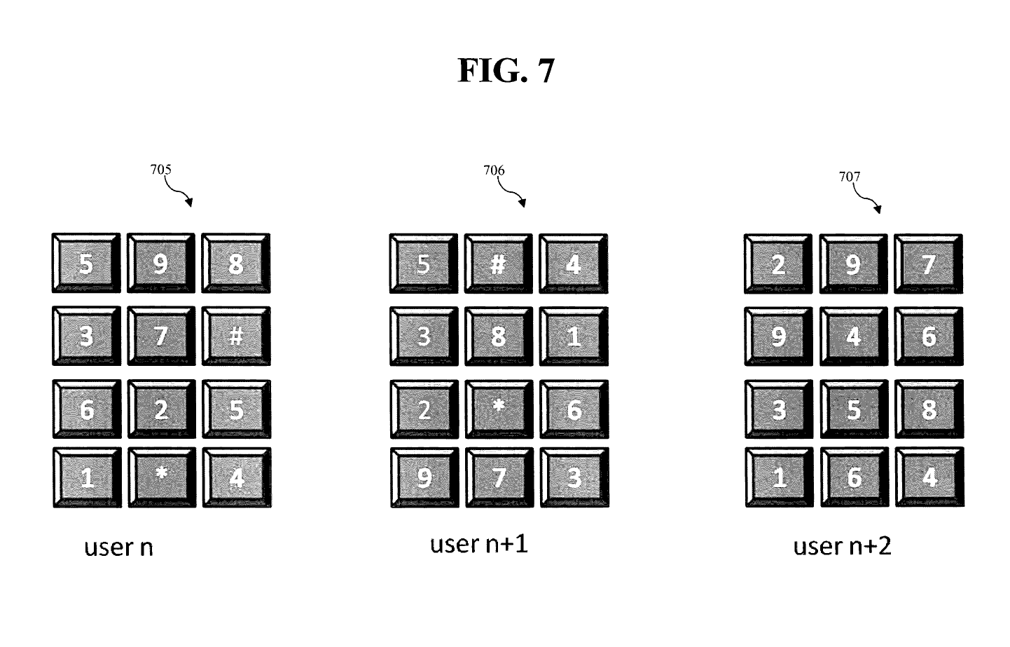

FIG. 7 illustrates exemplary arrangements of a variable arrangement keypad displayed on a touch screen according to an exemplary embodiment of the present invention.

Referring to FIG. 7, a variable arrangement keypad (e.g., a first variable arrangement keypad 705, a second variable arrangement keypad 706, or a third variable arrangement keypad 707) may display a plurality of keys in different arrangements for different users. For example, the first variable arrangement keypad 705 may display a first arrangement of keys to a first user (e.g., user n), the second variable arrangement keypad 706 may display a second arrangement of keys to a second user (e.g., user n+1), and the third variable arrangement keypad 707 may display a third arrangement of keys to a third user (e.g., user n+2). The variable arrangement keypad may be randomly arranged.

According to an exemplary embodiment of the present invention, the plurality of keys of the variable arrangement keypad may be displayed on a touch screen input device including a processor that executes stored codes to present the keypad having digits at different locations on the touch screen after each user session.

According to an exemplary embodiment of the present invention, a size of each of the plurality of keys may be variable. For example, a size of each of the plurality of keys may be changed after each user session. Thus, a relative position of each key from an earlier user session might not be readily detectable by a thermal imager.

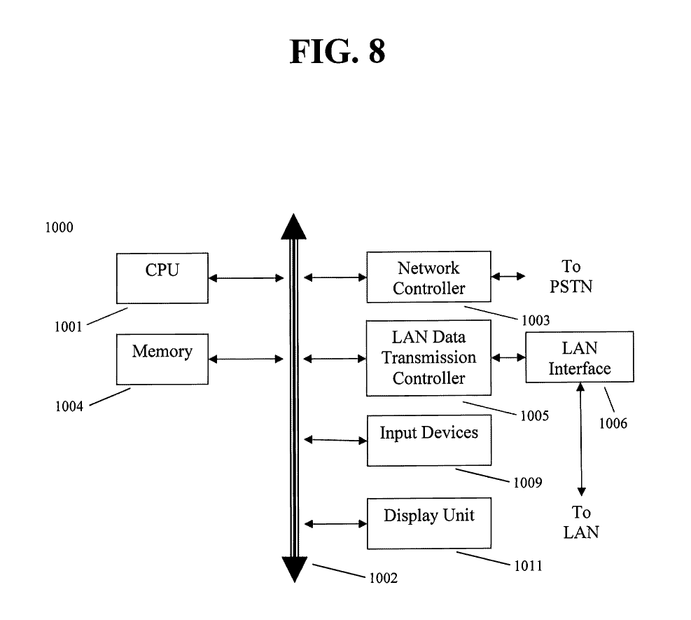

FIG. 8 illustrates an example of a computer system capable of implementing the method and apparatus according to embodiments of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device.

The input device 1009 may be the input device according to exemplary embodiments of the present invention. The input device 1009 may communicate with the CPU 1001. The input device 1009 may include a local processor or CPU disposed at the input device 1009. The CPU 1001 or the local processor or CPU disposed at the input device 1009 may execute stored codes according to exemplary embodiments of the present invention. For example, the stored codes may be executed by the processor to present the keypad having digits at different locations on the touch screen after each user session according to exemplary embodiments of the present invention. According to an exemplary embodiment of the present invention the stored codes executed by the processor may monitor the start and end of each user session.

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An input device comprising:
a keyboard having at least two keys;
a heating or cooling element connected to each key;
a sensor configured to detect temperature of each key; and
a controller connected to the sensor for controlling key temperature.

2. The device of claim 1, wherein the key temperature is maintained at a constant temperature.

3. The device of claim 2, wherein the temperature is maintained at or about human body temperature.

4. The device of claim 2, wherein the key temperature is maintained at different constant temperatures at different times.

5. The device of claim 2, wherein the key temperature is randomly varied over time.

6. The device of claim 1, wherein the heating or cooling element is embedded at each key.

7. The device of claim 1, wherein the sensor configured to detect temperature is embedded at each key.

8. The device of claim 1, further comprising an infrared (IR) source configured to illuminate the keys with infrared light.

9. The device of claim 8, wherein an infrared source is embedded at each key.

10. The device of claim 8, wherein the controller implements a PID loop.

11. The device of claim 1, wherein the heating or cooling element includes semiconductor material.

12. The device of claim 1, wherein the heating or cooling element is heated or cooled using the Peltier effect.

13. An input device comprising:
a keyboard having at least two keys and an infrared (IR) source configured to illuminate the keys with infrared light.

14. The device of claim 13, wherein an infrared source is embedded at each key.

15. The device of claim 13, wherein the at least two keys and the IR source are connected to a common power source node within the input device.

16. An input device comprising:
a keyboard having at least two keys and a motorized cover that covers the at least two keys after each user session.

17. The device of claim 16, wherein a processor executes stored codes to monitor the start and end of each user session.

18. An input device comprising:
a keyboard having at least two keys and a cover that covers the at least two keys, wherein the cover is configured to block infrared light and to pass humanly visible light.

19. A touch screen input device, comprising:
a processor that executes stored codes to present a keyboard having digits at different locations on the touch screen after each user session.
